(19) United States
(12) Patent Application Publication
(10) Pub. No.: US 2015/0104318 A1
(43) Pub. Date: Apr. 16, 2015

(54) TURBINE ROTOR FOR AN EXHAUST-GAS TURBINE AND METHOD FOR PRODUCING THE TURBINE ROTOR

(71) Applicant: CONTINENTAL AUTOMOTIVE GMBH, HANNOVER (DE)

(72) Inventors: Achim Koch, Tegernheim (DE); Timo Merenda, Regensburg (DE); Philipp Mehne, Mannheim (DE); Martin Thomas, Regensburg (DE); Guenter Muench, Carlsberg (DE)

(73) Assignee: CONTINENTAL AUTOMOTIVE GMBH, HANNOVER (DE)

(21) Appl. No.: 14/389,026

(22) PCT Filed: Mar. 20, 2013
(86) PCT No.: PCT/EP2013/055824

§ 371 Date: Sep. 29, 2014

(30) Foreign Application Priority Data
Mar. 29, 2012 (DE) 102012205043.4

(51) Int. Cl. F01D 5/30; B23K 1/00; B23K 1/20; B23K 1/005

(52) U.S. Cl. CPC F01D 5/3061; B23K 1/0056; B23K 1/0018; B23K 1/20
USPC 416/213 R; 219/121.14

(57) ABSTRACT

A turbine rotor as a turbine impeller made of a high-temperature-resistant metal alloy and a rotor shaft made of steel. The impeller hub and the rotor shaft end are connected together in a metallurgically bonded manner by way of a brazed connection. Between the end faces of the impeller hub and of the rotor shaft end, a brazing gap filled with brazing alloy is arranged concentrically with the rotation axis of the turbine rotor. A width of the soldering gap is previously determined by circularly peripheral removal of material on the end face of the impeller hub or the end face of the rotor shaft end, and the brazing connection is produced by an electron beam soldering process.

The present invention relates to a turbine rotor for an exhaust gas turbine and to a method for producing the turbine rotor.

Such a turbine rotor consists of a turbine wheel and a rotor shaft as a structural unit and is for example part of the running gear of an exhaust gas turbocharger and serves for the conversion of exhaust gas energy, contained in the exhaust gas of an internal combustion engine, into rotational energy of the running gear and for the transmission of this rotational energy to a compressor wheel connected to the turbine rotor, with the aid of which the rotational energy is used for generating an increased pressure of the air supply to the internal combustion engine, and consequently for increasing the output and efficiency of the internal combustion engine.

Instead, there may also be coupled to the turbine rotor for example a generator, with the aid of which the rotational energy is converted into electrical energy, which in turn can be used variously.

However, the main area of use at present concerns exhaust gas turbochargers for internal combustion engines in motor vehicles, for which reason, whenever useful for better understanding, hereafter reference is made in the description to exhaust gas turbochargers.

Exhaust gas turbochargers are being used increasingly for increasing the output in motor vehicle internal combustion engines. This is taking place increasingly frequently with the aim of reducing the internal combustion engine in overall size and weight, with the same output or even increased output, and at the same time reducing the consumption, and consequently the emission of CO₂, with regard to increasingly stringent legal specifications. The operating principle is that of using the energy contained in the stream of exhaust gas to increase the pressure in the induction tract of the internal combustion engine and thus bring about better filling of the combustion chamber with air-oxygen, and consequently be able to convert more fuel, petrol or diesel, in each combustion process, that is to say increase the output of the internal combustion engine.

An exhaust gas turbocharger has for this purpose a turbine arranged in the exhaust-system branch of the internal combustion engine, with a turbine rotor driven by the stream of exhaust gas and a compressor arranged in the induction tract, with a compressor impeller building up the pressure. The turbine rotor wheel and the rotor shaft are connected to one another in a material-bonded manner and thus form a structural unit. The compressor impeller is fastened to the end of the rotor shaft of the turbine rotor opposite from the turbine rotor wheel for rotation with said shaft, the rotor shaft being rotationally mounted in a bearing unit arranged between the turbine and the compressor. Consequently, with the aid of the mass flow of exhaust gas, the turbine rotor, and via the rotor shaft in turn the compressor impeller, is driven and the exhaust gas energy is thus used for building up pressure in the induction tract.

During operation, the turbine wheel is in the hot stream of exhaust gas, and is consequently exposed to very great temperature fluctuations, peak temperatures up to over 1000° C. being reached. At the same time, the turbine rotor rotates at very high rotational speeds of up to 300 000 rpm, whereby the turbine rotor wheel, and in particular the turbine wheel blading, is exposed to very high mechanical loads due to the high centrifugal forces occurring. Furthermore, particularly the mass of the turbine wheel is very important for the dynamic response of the turbine, which is hindered if the turbine rotor wheel is designed with a high mass to match the high loads.

Therefore, highly heat-resistant metal alloys, such as for example titanium-aluminum alloys (TiAl alloys or titanium aluminide) or Ni-based alloys, which are distinguished in particular by their high specific strength at high temperature and a nevertheless low relative density, are being used increasingly for the turbine rotor wheels. In addition, the coefficient of thermal expansion of these highly heat-resistant metal alloys comes very close to that of metals that are usually used in turbine construction, which helps to avoid problems caused by differing heat expansion. In practice, intermetallic mixtures with a main proportion of titanium and aluminum or nickel are used.

As also known for example from DE 10 2007 048 789 A1, in the case of the TiAl alloys the specific alloy compositions may well vary and also contain further constituents, and are typically characterized by a proportion of titanium of between 50 and 60% (proportion by weight) and a proportion of aluminum of greater than 25% (proportion by weight). Further constituents may be for example Cr, Nb, B, C or Mo. TiAl alloys form what is known as a γ-TiAl phase (gamma titanium aluminide) with a tetragonal crystal structure and, depending on the proportion of other different phases, are referred to as gamma, duplex or lamellar alloys.

The Ni-based alloys are for example Inco 713 C, Inco 713 LC, MAR-M 246 MAR-M 247, B 1964, IN 100 or GMR-235.

In the following explanations, all of these alloy structures are subsumed altogether under the term “highly heat-resistant metal alloys”.

On the other hand, the rotor shaft is part of the mounting system of the turbine rotor and must be able to withstand a high alternating bending load and must have a sufficiently hardened outer layer, at least in the mounting region, to avoid seizing of the bearings. On the other hand, the rotor shafts are not exposed to the same extreme high temperatures as the turbine rotor wheel.

Correspondingly suitable for this use are materials such as steel, in particular structural steel, low- or high-alloy heat-treatment steel, such as for example 42CrMo4(1.7225), X22CrMoV12-1(1.4923) or X19CrMoNbVN11-1(1.4913), or else superalloys such as Inconel or Incoloy (see also DE 10 2007 048 789 A1). These materials are referred to in the following explanations simply and altogether as steel.

In order to be able to use the respective advantages of the corresponding materials, the turbine rotors are therefore produced from the aforementioned components, the turbine rotor wheel of highly heat-resistant metal alloy and the rotor shaft of steel, and must as a consequence be advantageously joined together by means of a material-bonded connection to form a structural unit.

In the case of material-bonded connections, the elements being connected are held together by means of atomic or molecular forces and are inseparable connections that can only be released again destructively. In this context, material-bonded connections are in particular welded connections and brazed connections.

As known for example from DE 697 24 730 T2, the friction welding method known in this context in connection with other material combinations can only be used to a restricted extent. The reason for this is that, if a friction welding method is used, for example the transformation of the steel at the time of cooling down from austenite to martensite causes an expansion of the steel, which brings about a residual stress, and, even if the material of the turbine rotor wheel has a high rigidity, the formability at room temperature is approximately at a low 1%, and therefore rupturing of the wheels can occur. Furthermore, there may be a reaction of TiAl with the carbon, C, in the steel, whereby titanium carbide is formed at the connection interface, whereby the strength at the interface falls to a critical degree.

In the case of welding methods generally, the high temperatures, up to beyond the melting point of the materials to be connected, and the internal stresses occurring during cooling down increasingly cause crack formation in the region of the weld, and consequently weakening of the connection.

To avoid these problems, DE 697 24 730 T2 proposes a brazing method in which a brazing material that has for example an austenitic structure is inserted between the two elements to be connected, the turbine rotor wheel and the rotor shaft.

According to DIN 8505 “Soldering and brazing”, brazing is a thermal process for joining materials by material bonding, a liquid phase being produced by melting a brazing filler and a connection being created by diffusion of the brazing filler at the boundary surfaces. A further major difference from welding is that the solidus temperature of the base materials of the elements being joined is not reached thereby.

Consequently, this process takes place at lower temperatures than welding and fewer internal stresses are produced in the joint. Furthermore, the use of a corresponding brazing filler as an intermediate material between the elements being connected makes it possible to prevent the formation of microstructures that are detrimental to strength. According to DE 697 24 730 T2, primarily nickel-, copper-, silver- or titanium-based metal alloys are advantageously used as brazing materials.

One specific problem with these connecting processes is that of controlling the thickness of the layer of brazing filler between the two elements to be connected, and consequently controlling the overall length of the finished turbine rotor.

A further problem is that, even with the lower brazing temperatures, the austenite temperature of the steel used for the rotor shaft is possibly exceeded, and as a result a softening of the steel takes place. This problem is all the more serious the wider the heating region around the brazed connection extends, possibly into the bearing regions of the rotor shaft. This is the case in particular with the methods that are usually used for heating, by means of burners, induction coils or even heating ovens. As a result, renewed subsequent, cost- and time-intensive reworking and hardening of the rotor shaft is unavoidable. This is disadvantageous in particular for industrial mass production.

The present invention is therefore based on the object of providing a turbine rotor, consisting of a turbine rotor wheel of a highly heat-resistant metal alloy and a steel rotor shaft connected thereto by a brazing method, for an exhaust gas turbine, in which the width of the brazing gap, and consequently the exact length of the finished turbine rotor, and the hardening, in particular of the bearing regions, of the rotor shaft are defined, without requiring additional reworking. The object is also that of providing a method for producing such a turbine rotor that can be used at low cost industrially, in mass production.

This object is achieved by a turbine rotor with the features according to patent claim 1 and by a method for producing this turbine rotor with the features according to patent claim 5. Advantageous forms and developments that can be used individually or, as long as they are not mutually exclusive alternatives, in combination with one another are the subject of the dependent claims.

The turbine rotor according to the invention for an exhaust gas turbine has a turbine rotor wheel with a rotor wheel hub and a rotor shaft with a rotor shaft end facing the rotor wheel base. The turbine rotor wheel consists of a highly heat-resistant metal alloy and is preferably produced in a customary precision casting process. It has a main body with blading on the front side, and a rotor wheel hub in the form of a portion of a cylinder arranged concentrically on the rear side of the main body.

The rotor shaft consists of steel and is preferably finished for later use and hardened at least in the region of the later bearing locations.

The rotor wheel hub and the rotor shaft end are connected to one another in a metallurgically bonded manner by means of a brazed connection, a brazing gap filled with a brazing alloy being arranged concentrically in relation to the axis of rotation of the turbine rotor between the end faces of the rotor wheel hub and the rotor shaft end. Advantageously used as brazing materials are primarily nickel-, copper-, silver- or titanium-based metal alloys. The turbine rotor according to the invention is distinguished in particular by the fact that the brazing gap width is predetermined by material-removing machining, running around circularly and extending from the outer periphery over only part of the radius, on the end face of the rotor wheel hub or the end face of the rotor shaft end, and in that the brazed connection has been created by means of electron-beam brazing methods. The fact that the brazing gap is arranged concentrically and is formed by a removal of material running around circularly on one of the end faces, while the removal of material, and consequently the brazing gap, does not extend over the entire radius of the respective end face, means that part of the original end face remains, so that the removal of material produces a defined soldering gap when the end faces of the rotor wheel hub and the rotor shaft lie against one another. The corresponding removal of material may optionally take place both on the end face of the rotor wheel hub and on the end face of the rotor shaft end or on both faces.

The advantages of the turbine rotor according to the invention are in particular that a defined and optimized brazing gap width can be ensured in any event and independently of the applied forces when the two workpieces are joined to one another. This contributes to the constant quality of the brazed connection and its strength. Nevertheless, the spatially delimited heat input has the effect that the hardening of the rotor shaft is not impaired in the region of the bearing locations and there is no need for an additional hardening process. There are also no crack formations in the connecting region on account of the altogether lower temperatures. These are essential preconditions for use of the turbine rotor according to the invention in mass-produced products, such as for example in turbochargers for internal combustion engines in motor vehicles.

In an advantageous configuration of the turbine rotor according to the invention, a TiAl alloy or an Ni-based alloy is used as the highly heat-resistant metal alloy of the turbine rotor wheel and a low-alloy or high-alloy heat-treatment steel or an austenitic steel is used for the rotor shaft. This has the advantage that the optimum combination can be put together from a large multitude of known materials.

An advantageous configuration of the turbine rotor according to the invention is characterized in that the removal of material running around circularly forms an annular offset with a certain offset height, or a conical surface inclined at a certain gap angle α outwardly toward the respective workpiece, in such a way as to form an outwardly open brazing gap and a circular, end-face abutting surface adjoining thereto in the direction of the axis of rotation of the turbine rotor, which lies directly against the opposing end face. The removal of material therefore takes place from the outer circumference of the rotor shaft or the rotor wheel hub in the direction of the axis of rotation, over only part of the radius, so that part of the original end face remains in the respective center and forms the abutting surface for the respectively opposing workpiece.

As a result, a brazing gap with a defined width and length is predetermined, and consequently the connecting surface area is defined. This produces constant strength values of the brazed connections in mass production. At the same time, the turbine rotors have a constant overall length.

In a development of the aforementioned advantageous configuration, the rotor wheel hub or the rotor shaft end has in the respective end face a centrally arranged blind-hole bore, which acts as a thermal choke at the transition between the turbine rotor wheel and the rotor shaft. In this case, the diameter of the blind-hole bore is that much smaller than the diameter of the end-face abutting surface that an annular abutting surface with a ring width of at least 0.5 mm is formed. The blind-hole bore may be arranged both in the same workpiece, the turbine rotor or the rotor shaft, as that from which material has been removed or optionally also in the respectively other workpiece, from which material has not been removed. In the second case, the end-face abutting surface only lies against the opposing workpiece in the region in which the abutting surface overlaps the blind-hole bore.

This configuration has the advantage that a defined brazing gap width can be ensured in spite of the arrangement of the blind-hole bore as a thermal choke in one of the end faces of the rotor wheel hub or the rotor shaft.

In a continuation of the first-mentioned advantageous configuration of the turbine rotor according to the invention, the offset height of the annular offset is chosen as between 0.05 mm and 0.15 mm or the gap angle α is chosen such that the brazing gap does not exceed a brazing gap width of 0.20 mm at its outer circumference. With brazing gap widths or geometries within the aforementioned ranges, the connecting joints between the turbine rotor wheel and the rotor shaft have the best strength values.

The method according to the invention for producing the turbine rotor described above is characterized by the following method steps:
Firstly, a turbine rotor wheel of a highly heat-resistant metal alloy with a rotor wheel hub and a rotor shaft of steel are provided. The turbine rotor wheel is preferably produced in a customary precision casting process and has a main body with blading on the front side, and a rotor wheel hub in the form of a portion of a cylinder arranged concentrically on the rear side of the main body. Then a circular, concentric removal of material is carried out on one of the end faces of the rotor wheel hub or the rotor shaft, the removal of material, and consequently the brazing gap, which begins from the outside, not extending over the entire radius of the respective end face, so that the removal of material running around circularly forms an annular offset with a certain offset height, or a conical surface inclined at a certain gap angle α outwardly toward the respective workpiece, in such a way as to create an outwardly open brazing gap between the end faces of the rotor wheel hub and the rotor shaft and a circular, end-face abutting surface adjoining thereto in the direction of the axis of rotation of the turbine rotor.
After the previous step, a brazing material is then applied to one of the end faces of the rotor wheel hub or the rotor shaft, in the respective region where material has been removed, nickel-, copper, silver- or titanium-based metal alloys advantageously being used.
Then the two workpieces, the turbine rotor wheel and the rotor shaft, are brought together and aligned with one another in a centered manner. This takes place by clamping the workpieces in a device set up for this purpose in such a way that the end-face abutting surface lies directly against the opposing end face of the respectively other workpiece and the brazing material is positioned in the brazing gap.
This is followed by the heating up of the brazing material and the direct end face region of the rotor wheel hub and the rotor shaft in the brazing gap with the aid of an electron beam, up to a predetermined brazing temperature lying above the melting temperature of the brazing material.
After reaching the brazing temperature, this temperature is maintained as constantly as possible over a predetermined time, by means of a controlled supply of energy by the electron beam. This makes it possible for the connecting surface areas to be wetted by the brazing filler, and consequently improves the diffusion process of the brazing filler into the opposing connecting surface areas.

One possibility for carrying out the heating and temperature-maintaining operation is for example that the electron beam is focused in the form of a spot on one portion of the brazing gap, and the turbine rotor, that is to say the turbine rotor wheel and the rotor shaft together, is turned at a predetermined rotational speed about its axis of rotation.
The subsequent cooling down of the workpieces has the effect that the molten brazing filler solidifies, whereby the brazed connection between the turbine rotor wheel and the rotor shaft is created.
After the brazing location has set firm, the turbine rotor can be released from the device.

The advantages of the method according to the invention for producing the turbine rotor according to the invention are in particular that a brazed connection of a constant quality with a defined brazing gap width, and consequently a defined overall length of the turbine rotor, can in any event be produced. The rapid and spatially delimited introduction of heat allows short process times to be achieved, and no subsequent operation of hardening the rotor shaft is required. These are essential preconditions for use of the method according to the invention in mass production, such as for example in turbochargers for internal combustion engines in motor vehicles.

An advantageous development of the method for producing a turbine rotor according to the invention is characterized in that, in an additional method step, a centrally arranged blind-hole bore is introduced into the rotor wheel hub or the rotor shaft end in such a way that the diameter of the blind-hole bore is that much smaller than the diameter of the end-face abutting surface that an annular abutting surface with a ring width of at least 0.5 mm is formed.

The blind-hole bore introduced acts as a thermal choke between the turbine rotor wheel and the rotor shaft and reduces the heat transfer to the rotor shaft during operation. At the same time, a brazing gap defined in length and width can be achieved, and the quality of the brazed connection can be increased as a result.

Summarized in brief, the invention relates to a turbine rotor for an exhaust gas turbine and to a method for producing such a turbine rotor, the turbine rotor having a turbine rotor wheel of a TiAl alloy and a rotor shaft of steel, and the rotor wheel hub and the rotor shaft end being connected to one another in a material-bonded manner by means of a brazed connection. A brazing gap filled with a brazing alloy is arranged concentrically in relation to the axis of rotation of the turbine rotor between the end faces of the rotor wheel hub and the rotor shaft end, the brazing gap width being predetermined by a removal of material, running around circularly, on the end face of the rotor wheel hub or the end face of the rotor shaft end, and the brazed connection being produced by means of electron-beam brazing methods.

Specific exemplary embodiments of the invention are explained in more detail below on the basis of the representations in the drawing, in which:

FIG. 1 shows a simplified schematic representation, not to scale, of an embodiment of the turbine rotor according to the invention.

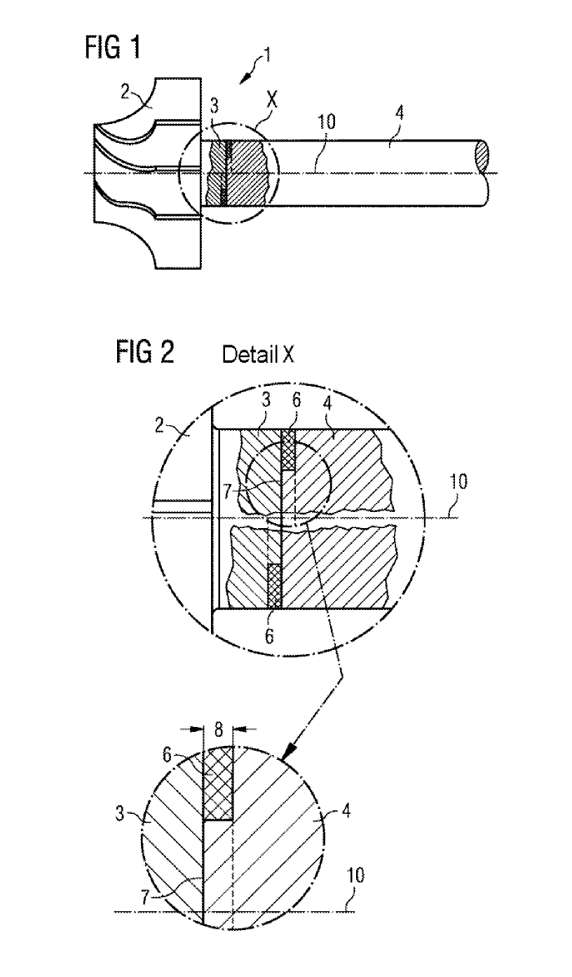

FIG. 2 shows a characterizing detail from FIG. 1 in two different configurations in an enlarged representation.

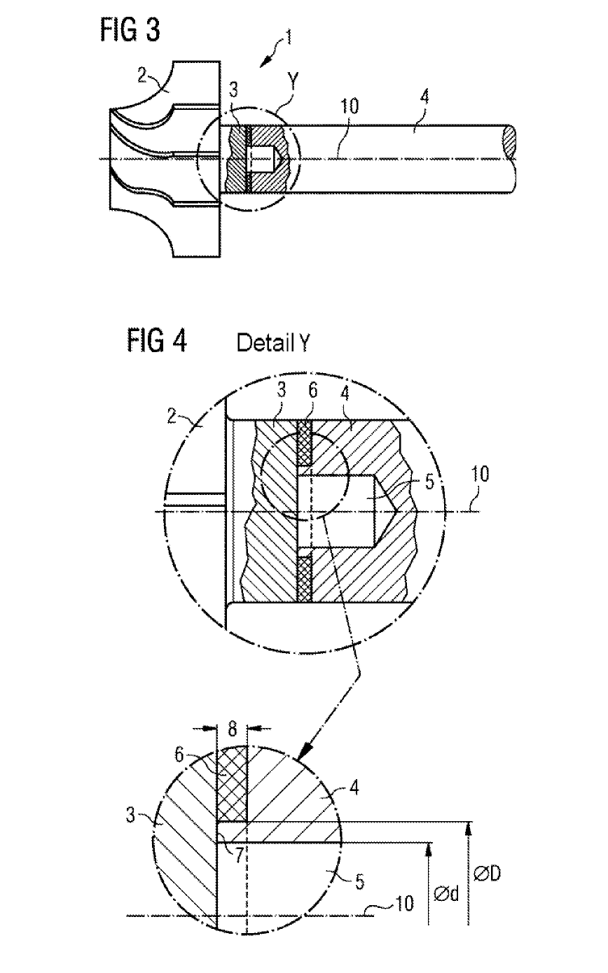

FIG. 3 shows a simplified schematic representation, not to scale, of a further embodiment of the turbine rotor according to the invention.

FIG. 4 shows a characterizing detail from FIG. 3 in an enlarged representation.

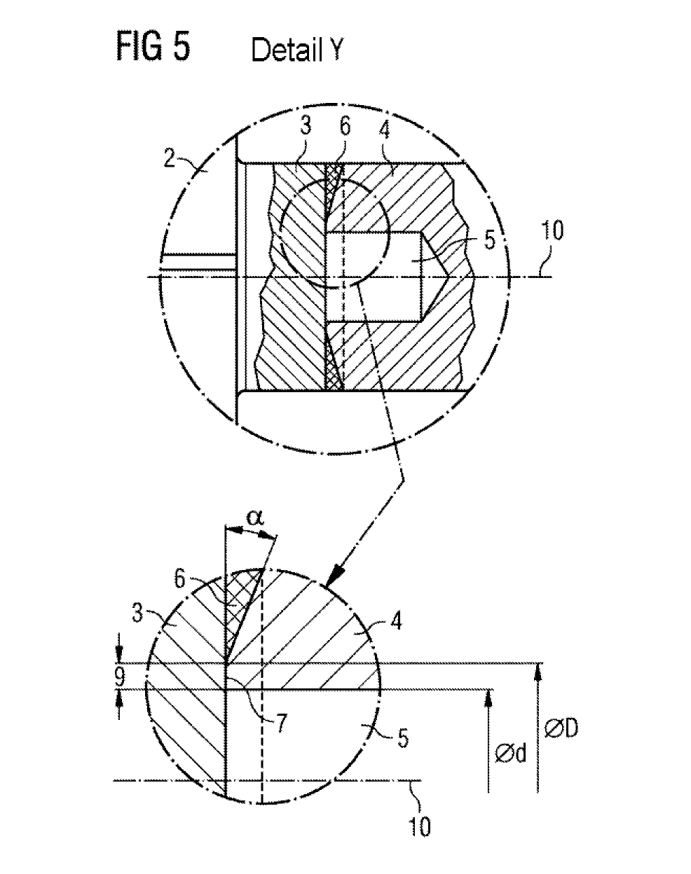

FIG. 5 shows a further configuration of the characterizing detail from FIG. 3 in an enlarged representation.

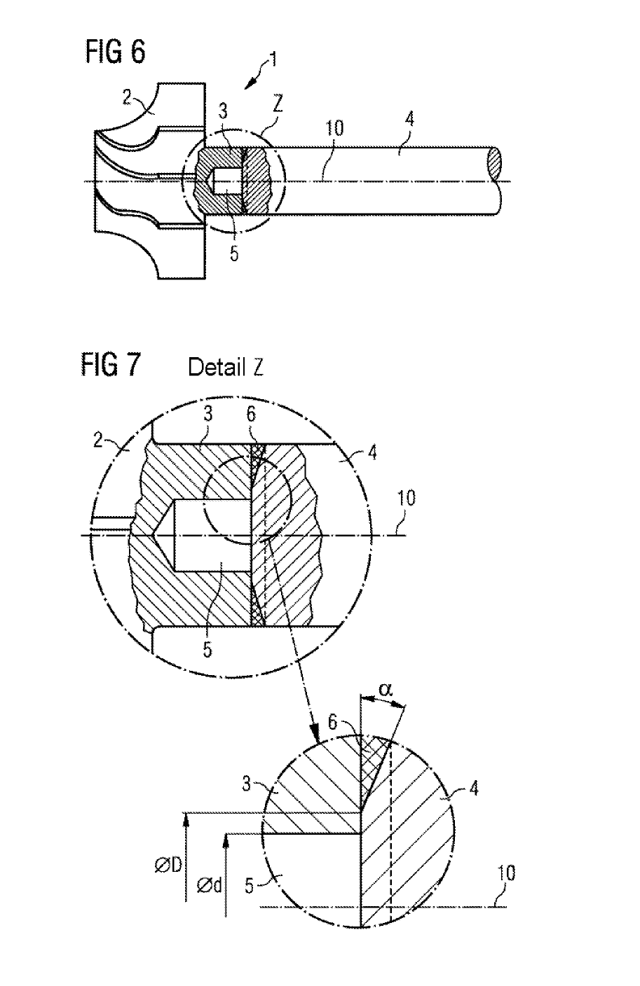

FIG. 6 shows a simplified schematic representation, not to scale, of a further embodiment of the turbine rotor according to the invention.

FIG. 7 shows a characterizing detail from FIG. 6 in an enlarged representation.

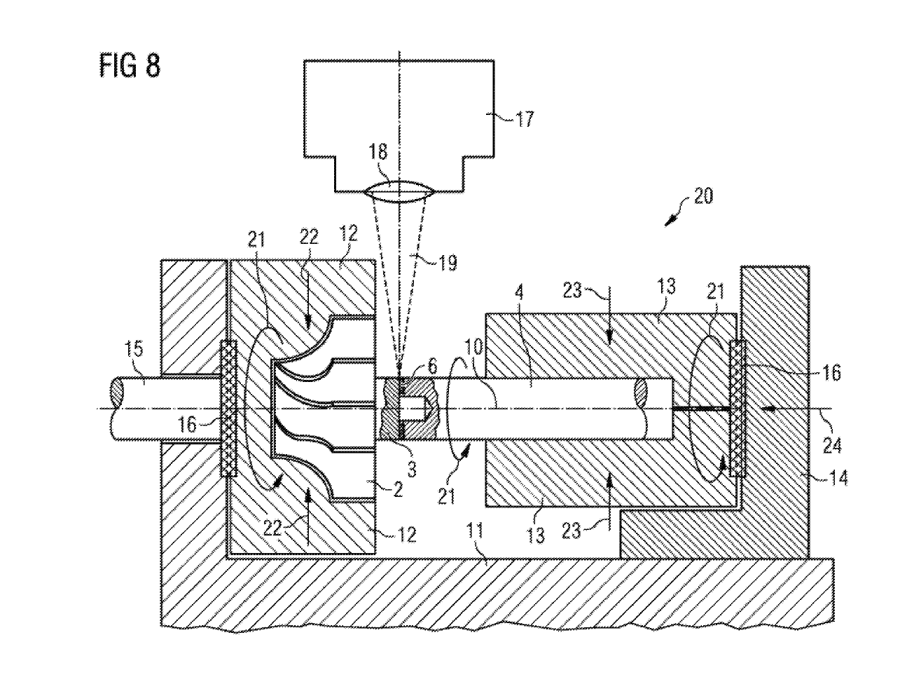

FIG. 8 shows a greatly simplified representation of a device for carrying out at least part of the method according to the invention.

Items that have the same function and designation are provided in the figures with the same reference signs.

In FIG. 1, a turbine rotor 1 according to the invention is shown in a simplified representation. This rotor has a turbine rotor wheel 2 with a rotor wheel hub 3 and a rotor shaft 4. The turbine rotor wheel is preferably produced in a customary precision casting process from a highly heat-resistant metal alloy and has a main body with blading on the front side (on the left in the figure), and also a rotor wheel hub 3 in the form of a portion of a cylinder arranged concentrically on the rear side (on the right in the figure) of the main body. The shaft is likewise represented in a simplified form here and in a specific case may have steps, offsets, tapers and similar features.

The connecting joint between the turbine rotor wheel and the rotor shaft is shown in a “broken-away” representation and identified as detail X, which in the following FIG. 2 is shown in an enlarged representation for a better overview.

In FIG. 2, the interface between the rotor wheel hub 3 and the rotor shaft 4 is shown in two complementary embodiments, a brazing gap 6 filled with a brazing alloy being arranged concentrically in relation to the axis of rotation 10 of the turbine rotor 1 between the end faces of the rotor wheel hub 3 and the end face of the rotor shaft 4. In the upper half of the representation identified as detail X, the brazing gap width 8 is predetermined by a removal of material, running around circularly and extending from the outer periphery over only part of the radius, in the form of a right-angled offset, on the end face of the rotor shaft end. In the center, the remaining part of the rotor shaft end face forms an abutting surface 7, with which the rotor shaft end lies directly against the end face of the rotor wheel hub 3. This can be seen well in the lower part of FIG. 2, where specifically the region of the brazing gap 6 and the abutting surface 7 is shown in a further enlarged representation. Shown in the lower half of the representation identified as detail X is a brazing gap 6 with the same geometry, which however, by contrast with the aforementioned configuration, is predetermined by removal of material on the end face of the rotor wheel hub.

The brazed connection is produced by means of electron-beam brazing methods.

FIG. 3 shows in principle the same turbine rotor 1 as FIG. 1. However, in the region of the interface between the rotor wheel hub 3 and the rotor shaft 4 that is identified here as detail Y, there is additionally provided in the rotor shaft end a centrally arranged blind-hole bore 5, which acts as a thermal choke at the transition between the turbine rotor wheel and the rotor shaft.

In the enlarged representation of the detail Y from FIG. 3 in FIG. 4 it can be seen that also in this configuration the brazing gap width 8 is predetermined by a removal of material, running around circularly and extending from the outer periphery over only part of the radius, in the form of a right-angled offset, on the end face of the rotor shaft end. Here, too, the region of the brazing gap 6 and the abutting surface 7 is shown in a further enlarged representation in the lower part of FIG. 4. Here it can be seen well that the diameter d of the blind-hole bore 5 is smaller than the diameter D of the end-face abutting surface 7, so that an annular abutting surface 7 with a ring width 9 is formed. In the specific configuration, this ring width 9 should be at least 0.5 mm, in order to ensure a sufficient load-bearing capacity with respect to a pressing pressure to be applied in the joining process.

FIG. 5 shows in an enlarged representation of the detail Y from FIG. 3 a further variant of the fashioning of a defined brazing gap 6 in connection with a blind-hole bore 5. Both the removal of material for fashioning the brazing gap 6 and the blind-hole bore 5 are arranged on the end face of the rotor shaft 4. Here, too, specifically the region of the brazing gap 6, the blind-hole bore 5 and the abutting surface 7 is shown in a further enlarged representation in the lower part of FIG. 5. In this configuration, the brazing gap 6 has the form of a wedge. For the fashioning of the brazing gap 6, a conical surface that is inclined at a certain gap angle α outwardly toward the rotor shaft is formed in such a way as to form an outwardly open brazing gap, which tapers in the form of a wedge in the direction of the axis of rotation 10 of the turbine rotor and comes to an end already before reaching the periphery of the blind-hole bore, so that a circular abutting surface 7 adjoining thereto remains on the end face of the rotor shaft 4 and lies directly against the opposing end face of the rotor wheel hub. Here, too, the diameter d of the blind-hole bore 5 is smaller than the diameter D of the end-face abutting surface 7, so that an annular abutting surface 7 with a sufficient ring width 9 is formed.

The examples of the possible arrangements and combinations of the removal of material and the blind-hole bore that are shown should be understood as merely examples of the further possible combinations and further geometries of the removal of material or fashioning of the brazing gap.

This is illustrated once again in FIGS. 6 and 7, which show a variant of the turbine rotor 1 in which the removal of material for fashioning the brazing gap is arranged on the end face of the rotor shaft 4, but the blind-hole bore 5 is arranged in the rotor hub 3. Here, too, the diameter d of the blind-hole bore 5 is smaller than the diameter D of the end-face abutting surface 7, so that here, too, an annular abutting surface 7 with a sufficient ring width 9 is formed by the overlapping region.

FIG. 8 shows in a greatly simplified representation a device for carrying out various method steps of the method according to the invention. The device represented serves in particular for carrying out the brazing process for the material-bonded connection between the rotor wheel hub 3 and the rotor shaft 4. After separately carrying out the first method steps:
providing the turbine rotor wheel and the rotor shaft,
producing a circular, concentric removal of material on one of the end faces of the rotor wheel hub or the rotor shaft and
applying a brazing material to one of the end faces, at least the following method steps are performed by using a device such as that represented for example in FIG. 8.

The device has a clamping device 20 and an electron beam source 17 with a focusing device 18. The clamping device 20 has the following functional units:
A device bed 11 as a base for the further functional units.
A rotor wheel clamping chuck 12, consisting of at least two clamping jaws for receiving the turbine rotor wheel 2 in a centered manner, the rotor wheel clamping chuck 12 being mounted on the device bed 11 rotatably about the axis of rotation 10 of the turbine rotor by means of a rotary bearing 16 and being capable of being driven by way of a drive shaft 15.
A clamping slide 14, which is mounted in the device bed 11 in such a way that it can be made to move axially, in the direction of the axis of rotation 10 of the turbine rotor.
A rotor shaft clamping chuck 13, consisting of at least two clamping jaws for receiving the rotor shaft 4 in a centered manner and mounted on the clamping slide 14 rotatably about the axis of rotation 10 of the turbine rotor by means of a rotary bearing 16.

The turbine rotor wheel 2 provided, prepared in a way corresponding to the first method steps, is clamped in a centered manner in the rotor wheel clamping chuck 12; the arrows 22 show the clamping movement of the individual clamping jaws that is required for this. Likewise, the rotor shaft provided, prepared in a way corresponding to the first method steps, is clamped in a centered manner in the rotor shaft clamping chuck 13; the arrows 23 show the clamping movement of the individual clamping jaws that is required for this. This is followed by the bringing together of the turbine rotor wheel 2 and the rotor shaft 4, which are aligned with one another in a centered manner, by way of a linear movement of the clamping slide 14, which is indicated in FIG. 8 by means of the arrow 24, in such a way that the end-face abutting surface lies directly against the opposing end face of the respectively other workpiece and the brazing material is positioned in the brazing gap 6. The clamping slide 14 then applies a predefined clamping force, with which the two workpieces are pressed against one another. As a consequence, driven by way of the drive shaft 15, the turbine rotor wheel 2, together with the rotor shaft 4 coupled thereto by means of force closure, is then set in rotation at a predetermined, controlled rotational speed about the axis of rotation 10 of the turbine rotor, which is indicated in FIG. 8 by the arrows 21. With the aid of the electron beam source 17 and the focusing device 18, an electron beam 19 is then generated and directed from the outside onto the brazing gap 6. By the uniform turning of the turbine rotor 1 in interaction with the electron beam 19, the heating up of the brazing material and of the direct end face region of the rotor wheel hub 3 and the rotor shaft 4 then takes place in the brazing gap 6, up to a predetermined brazing temperature lying above the melting temperature of the brazing material. In this case, the heating rate and the temperature level to be reached can be influenced by the rotational speed of the turbine rotor and the intensity of the electron beam 19. In order to ensure good wetting of the opposing end faces by the brazing filler, the brazing temperature is thus maintained over a predetermined time, by means of a controlled supply of energy by the electron beam 19 along with a constant rotational speed of the turbine rotor. After that, the cooling down of the workpieces takes place, and the associated creation of the brazed connection between the turbine rotor wheel and the rotor shaft. The clamping force produced by the clamping slide 14 is thereby maintained at least until the brazing filler solidifies and the connection is stable. Only then is the turbine rotor released from the device.

All of the procedures described can be carried out in an automated manner with the aid of corresponding drive devices and a central programmable open-loop/closed-loop control device. The arrangement of further functional units also allows the foregoing method steps, such as for example the production of the circular, concentric removal of material and the application of a brazing material, to be carried out at least partially in the device described.

1-8. (canceled)

9. A turbine rotor for an exhaust gas turbine, the turbine rotor comprising:
turbine rotor wheel consisting of a highly heat-resistant metal alloy and having a rotor wheel hub with a rotor wheel base;
a rotor shaft consisting of steel and having rotor shaft end facing said rotor wheel base;
said rotor wheel hub and said rotor shaft end being connected to one another by way of a brazed connection forming a metallurgical bond;
wherein a brazing alloy is disposed in a brazing gap arranged concentrically in relation to an axis of rotation of the turbine rotor between an end face of said rotor wheel hub and an end face of said rotor shaft end;
said brazing gap having a predetermined brazing gap width formed by a removal of material, running around circularly and extending from an outer periphery over only part of the radius, on said end face of said rotor wheel hub or said end face of said rotor shaft end, and wherein said brazed connection is a connection formed by way of an electron-beam brazing process.

10. The turbine rotor according to claim 9, wherein said highly heat-resistant metal alloy of said turbine rotor wheel is a TiAl alloy or an Ni-based alloy and said steel of said rotor shaft is a low-alloy or high-alloy heat-treatment steel or an austenitic steel.

11. The turbine rotor according to claim 9, wherein the removal of material running around circularly forms an annular offset with a given offset height, or a conical surface inclined at a certain gap angle α outwardly toward the respective workpiece, so as to form an outwardly open brazing gap and a circular, end-face abutting surface adjoining thereto in the direction of the axis of rotation of the turbine rotor, which lies directly against the opposing end face.

12. The turbine rotor according to claim 11, wherein an offset height of said annular offset lies between 0.05 mm and 0.15 mm.

13. The turbine rotor according to claim 11, wherein the gap angle α is chosen such that the brazing gap does not exceed a brazing gap width of 0.20 mm at an outer periphery.

14. The turbine rotor according to claim 9, wherein said rotor wheel hub or said rotor shaft end is formed with a centrally arranged blind-hole bore, configured to act as a thermal choke at a transition between said turbine rotor wheel and said rotor shaft, said blind-hole bore having a diameter substantially smaller than a diameter of the end-face abutting surface, forming an annular abutting surface with a ring width of at least 0.5 mm is formed.

15. A method of producing a turbine rotor according to claim 9, the method comprising the following method steps:
providing workpieces, including a turbine rotor wheel of a highly heat-resistant metal alloy with a rotor wheel hub and a rotor shaft of steel;
forming on one of the workpieces, by circular, concentric removal of material on one of the end faces of the rotor wheel hub or the rotor shaft, an annular offset with a certain offset height, or a conical surface inclined at a certain gap angle α outwardly toward the respectively other workpiece, in such a way as to create an outwardly open brazing gap between the end faces of the rotor wheel hub and the rotor shaft and a circular, end-face abutting surface adjoining thereto in the direction of the axis of rotation of the turbine rotor;
applying a brazing material at one of the end faces of the rotor wheel hub or the rotor shaft, in the respective region where material has been removed;
bringing together and aligning in a centered manner the turbine rotor wheel and the rotor shaft by clamping the workpieces in a suitable device such that the end-face abutting surface lies directly against the opposing end face of the respectively other workpiece and the brazing material is positioned in the brazing gap;
heating up the brazing material and the directly adjoining end face region of the rotor wheel hub and the rotor shaft in the brazing gap by irradiation with an electron beam, up to a predetermined brazing temperature above the melting temperature of the brazing material;
maintaining the brazing temperature over a predetermined time by way of a controlled supply of energy via the electron beam;
cooling down the workpieces and creating the brazed connection between the turbine rotor wheel and the rotor shaft; and
releasing the turbine rotor from the device.

16. The method according to claim 15, which further comprises, after carrying out the concentric removal of material, applying a flux to the two end faces to be connected, of the rotor wheel hub and the rotor shaft, in the region where material has been removed.

17. The method according to claim 15, which further comprises creating a centrally arranged blind-hole bore in the rotor wheel hub or the rotor shaft end, the blind-hold bore having a diameter substantially smaller than a diameter of the end-face abutting surface, in order to form an annular abutting surface with a ring width of at least 0.5 mm.
